(19) United States
(12) Patent Application Publication
(10) Pub. No.: US 2019/0152149 A1
(43) Pub. Date: May 23, 2019

(54) METHOD OF FABRICATING LAST

(71) Applicant: DREAM GP INC., Osaka-shi, Osaka (JP)

(72) Inventor: Motohide ARAYAMA, Osaka-shi, Osaka (JP)

(73) Assignee: DREAM GP INC., Osaka-shi, Osaka (JP)

(21) Appl. No.: 15/772,684

(22) PCT Filed: Nov. 4, 2016
(86) PCT No.: PCT/JP2016/082883

§ 371 Date: Jun. 5, 2018

(30) Foreign Application Priority Data
Nov. 6, 2015 (JP) 2015-218913

(51) Int. Cl. B29C 64/386; A43D 3/02; B29C 64/124; B29C 33/38

(52) U.S. Cl. CPC B29C 64/386; A43D 3/02; B33Y 70/00; B29C 33/3842; B29C 64/124

(57) ABSTRACT

The objective of the present invention is to use a 3D printer to fabricate, in as short a time as possible, a last that can be used when manufacturing a shoe. The surface shape of the last is determined on the basis of three-dimensional data obtained by measuring the three-dimensional shape of a foot, an outer section having a hollow space therein is shaped using a 3D printer in such a way that the shape of the outer surface of the outer section matches the determined surface shape, when shaping of the outer section is complete, or when the outer section has been partly shaped, the inside thereof is filled with uncured filler. A last including the outer section and the cured filler in contact with the inner surface of the outer section is fabricated in this way.

### TECHNICAL FIELD

The present invention relates to a method of fabricating last, more particularly, to a method of fabricating last for use in the manufacturing of shoes.

### BACKGROUND ART

Lasts are used in the manufacturing of shoes. For example, a last to which an insole is temporarily attached by driving nails is covered with an upper (produced instep) obtained by sewing parts, the edge of the upper is drawn so as to wrap the last to fix the upper to the insole, and then a main sole is attached to the insole. Since the shape of the shoe is determined by the last, the shape of the last significantly affects the wear feeling of the shoe.

Hence, fabricating a last according to the shape of a foot using data obtained by measuring the three-dimensional shape of the foot has been proposed in order to manufacture a shoe fitted to the foot (for example, refer to Patent Documents 1 and 2).

### PRIOR ART DOCUMENTS

### Patent Documents

Patent Document 1: Japan Patent Publication No. 5-507630

Patent Document 2: Japan Patent Publication No. 2003-52416

### SUMMARY OF THE INVENTION

### Problem that the Invention is to Solve

In the case that a last is fabricated using data obtained by measuring the three-dimensional shape of a foot, the last is fabricated by performing shaving using an NC machine tool. However, the NC machine tool is expensive and generates chips, thereby wastefully consuming materials.

For the purpose of solving these problems, it is conceivable that a last is manufactured using a 3D printer. Such a 3D printer is declining in price and does not wastefully consume materials.

However, since the kinds of materials that can be used with the 3D printer are limited, it is very difficult to manufacture a last (for example, a last into which nails can be driven and which is not broken or deformed even if pressure and impact are applied thereto) that can be used in the manufacturing of a shoe. Furthermore, the type of 3D printer that forms a three-dimensional shape by attaching materials takes a longer processing time than the type that performs shaving.

In consideration of the above-mentioned circumstances, the present invention is intended to provide a last manufacturing method capable of manufacturing a last that can be used for manufacturing a shoe in as short time as possible using a 3D printer.

### Means for Solving the Problem

The present invention provides the method of fabricating last configured as described below in order to solve the above-mentioned problems.

The method of fabricating last has (i) a shaping step for shaping an outer section having a hollow space using a 3D printer and (ii) an injecting step for injecting a filling material being in an uncured state into the inside of the outer section that has been shaped at the shaping step or that has been shaped partly at the shaping step.

With the above-mentioned method, a last that can be used for manufacturing a shoe can be fabricated in as short time as possible using a 3D printer.

The method of fabricating last according to a preferred first embodiment further has a surface shape determining step for determining the surface shape of a last on the basis of the three-dimensional data obtained by measuring the three-dimensional shape of a foot. At the shaping step, the outer section is shaped using the 3D printer so that the shape of the outer face of the outer section becomes coincident with the surface shape determined at the surface shape determining step. The last having the outer section and the filling material being cured and making contact with the inner face of the outer section is fabricated.

With the above-mentioned method, in the case that, for example, the outer section is shaped so that nails can be driven thereinto and the strength of the outer section is secured using the filling material, it is possible to fabricate a last into which nails can be driven and which is not broken or deformed even if pressure and impact are applied thereto. The outer section having the hollow space therein can be shaped using the 3D printer in a shorter time than in the case that the entire last is shaped using the 3D printer. Hence, the last that can be used for manufacturing a shoe can be manufactured in as short time as possible using the 3D printer.

At the shaping step, an inner section expanded inside the outer section with a distance provided between the inner section and the outer section is preferably shaped together with the outer section using the 3D printer. At the injecting step, the filling material being in an uncured state is injected into the space between the outer section and the inner section. The last having the filling material disposed between the outer section and the inner section is fabricated.

In this case, the filling material is disposed between the outer section and the inner section, whereby the amount of the material to be used can be reduced and the last can be made light in weight while strength is secured.

The method of fabricating last according to a preferred second embodiment further has a surface shape determining step for determining the surface shape of a last on the basis of the three-dimensional data obtained by measuring the three-dimensional shape of a foot. At the shaping step, the outer section is shaped using the 3D printer so that the shape of the inner face of the outer section becomes coincident with the surface shape determined at the surface shape determining step. The method further has a removing step to remove the outer section from the filling material after the filling material injected at the injecting step is cured in the state of making contact with the inner face of the outer section. The last formed of the filling material to which the shape of the inner face of the outer section has been transferred is fabricatred.

With the above-mentioned method, the last that can be used at the time of manufacturing a shoe can be fabricated by appropriately selecting the materials of the outer section and the filling material. The outer section having the hollow space therein can be shaped using the 3D printer in a shorter time than in the case that the entire last is shaped using the 3D printer. Hence, the last that can be used for manufacturing the shoe can be fabricated in as short time as possible using the 3D printer.

The method of fabricating last according to the above-mentioned first and second embodiments can be embodied by various kinds of specific modes as described below.

At the shaping step, the outer section is preferably shaped using a material consisting essentially of a thermoplastic resin or a photo-curable resin. The filling material being in a cured state consists essentially of at least one of plaster, cement, foamed urethane, non-foamed urethane, elastomer and photo-curable resin.

In this case, the last can be fabricated simply using an inexpensive 3D printer.

At the injecting step, the filling material being in an uncured state is preferably injected into the inside of the outer section having been shaped partly at the shaping step. For example, the injection of the filling material is performed simultaneously with the shaping of the outer section. Alternatively, the injection of the filling material is performed by interrupting the shaping of the outer section.

In this case, the time required for the last manufacturing step can be made shorter than in the case that the filling material is injected and cured collectively after the shaping of the outer section. Moreover, even in the case of a filling material that generates heat or changes in volume when it cures, the last can be fabricated while relieving the influence of the heat generation and the change in volume by injecting the filling material little by little.

At the shaping step, the outer sections of the pair of lasts corresponding to left and right feet are preferably shaped simultaneously using the two separate 3D printers.

In this case, the required time can be made shorter than the time required in the case that the outer sections of the pair of lasts are shaped using one 3D printer. Furthermore, since the two 3D printers are prepared, in the case that one of the 3D printers cannot be used, the outer sections of the pair of lasts can be shaped using the other 3D printer, whereby the fabricating of the pair of lasts can be continued.

The method of fabricating last preferably further has (iii) a shoe design selecting step for selecting the design of a shoe before the shaping step and (iv) a shoe-wearing simulating step for creating a shoe-wearing image figure of the shoe by simulating the shape of the shoe at the time when the shoe with the selected design is manufactured and worn before the shaping step.

In this case, after the confirmation of the shoe-wearing image figure at the time of wearing the shoe with the selected design, the last is actually fabricated and the shoe can be manufactured using the last.

The method of fabricating last preferably further has (v) a temporary shoe shaping step for shaping a temporary shoe for trial fitting using a 3D printer being the same as or different from the 3D printer on the basis of the surface shape determined at the surface determining step after the surface shape determining step and before the shaping step.

In this case, after the temporary shoe for trial fitting shaped using the 3D printer is worn and the contact state and the wear feeling of the shoe, for example, are confirmed, a last is fabricated actually, and a shoe can be manufactured using the last.

Moreover, the present invention provides a last configured as described below.

The last has (a) an outer section having a hollow space therein and (b) a filling material disposed inside the outer section and making contact with the outer section. The outer section is made of a material consisting essentially of a thermoplastic resin or a photo-curable resin. The filling material consists essentially of at least one of plaster, cement, foamed urethane, non-foamed urethane, elastomer and photo-curable resin.

With the above-mentioned configuration, in the case that, for example, the outer section is shaped so that nails can be driven thereinto and the strength of the outer section is secured using the filling material, it is possible to fabricate a last into which nails can be driven and which is not broken or deformed even if pressure and impact are applied thereto. The outer section having a hollow space therein can be shaped using the 3D printer in a shorter time than in the case that the entire last is shaped using the 3D printer. Hence, the last that can be used for manufacturing a shoe can be manufactured in as short time as possible using the 3D printer.

### Advantage of the Invention

With the present invention, a last that can be used for manufacturing a shoe can be manufactured in as short time as possible using a 3D printer.

### BRIEF DESCRIPTION OF THE DRAWINGS

FIG. 1 is an explanatory view showing an entire configuration of a system for selling custom-made shoes at a store (Embodiment 1);

FIG. 2 is an image figure showing a 3D printer (Embodiment 1);

FIG. 3 is a sectional view showing a step for fabricating a last (Embodiment 1);

FIG. 4 is a sectional view showing a step for fabricating a last (Modification 1 of Embodiment 1);

FIG. 5 is a sectional view showing a step for fabricating a last (Embodiment 1);

FIG. 6 is a sectional view showing a step for fabricating a last (Modification 2 of Embodiment 1);

FIG. 7 is a sectional view showing a step for fabricating a last (Modification 3 of Embodiment 1);

FIG. 8 is a sectional view showing a last (Modification 4 of Embodiment 1);

FIG. 9 is a flow chart indicating a procedure ranging from designing a last and to fabricating the last (Embodiment 1);

FIG. 10 is an image figure showing a procedure for determining the surface shape of a last (Embodiment 1);

FIG. 11 is an image figure showing a procedure for determining the surface shape of the last (Embodiment 1);

FIG. 12 is an image figure showing a procedure for determining the surface shape of the last (Embodiment 1);

FIG. 13 is an image figure showing a procedure for determining the surface shape of the last (Embodiment 1);

FIG. 14 is an image figure showing a procedure for determining the surface shape of the last (Embodiment 1);

FIG. 15 is an image figure showing a procedure for determining the surface shape of the last (Embodiment 1);

FIG. 16 is an image figure showing a procedure for determining the surface shape of the last (Embodiment 1);

FIG. 17 is an image figure showing a procedure for determining the surface shape of the last (Embodiment 1);

FIG. 18 is an image figure showing a procedure for determining the surface shape of the last (Embodiment 1);

FIG. 19 is an image figure showing a procedure for determining the surface shape of the last (Embodiment 1);

FIG. 20 is an image figure showing a procedure for determining the surface shape of the last (Embodiment 1);

FIG. 21 is an image figure showing a procedure for determining the surface shape of the last (Embodiment 1);

FIG. 22 is a sectional view showing a step for fabricating a last (Modification 6 of Embodiment 1);

FIG. 23 is a schematic view showing a 3D printer (Modification 7 of Embodiment 1);

FIG. 24 is a schematic view showing the head section of the 3D printer (Modification 7 of Embodiment 1);

FIG. 25 is an explanatory view showing the operation of the head section of the 3D printer (Modification 7 of Embodiment 1);

FIG. 26 is an explanatory view showing an entire configuration of a system for mail-order selling custom-made shoes (Embodiment 2); and

FIG. 27 is a sectional view showing processing for fabricating a last (Embodiment 3).

### MODE FOR CARRYING OUT THE INVENTION

Modes for embodying the present invention will be described below referring to the drawings.

### Embodiment 1

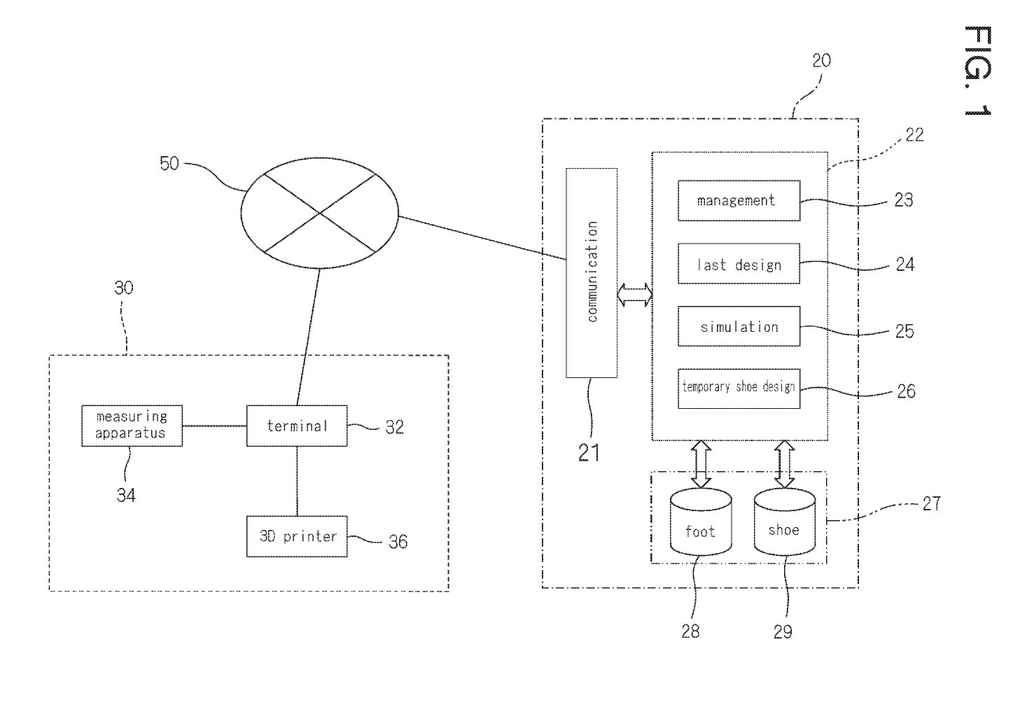

A system for selling custom-made shoes at a store according to Embodiment 1 for embodying a method of fabricating last according to the present invention will be described referring to FIGS. 1 to 25.

The system for selling custom-made shoes at a store according to Embodiment 1 makes it possible to manufacture shoes (custom-made shoes) fitted to the feet of a customer at a shoe store. In the system for selling custom-made shoes at a store, a last design server automatically designs a last on the basis of the three-dimensional shape of each foot of a customer, and the shoe store fabricates the last using a 3D printer and manufactures a shoe using the last.

FIG. 1 is an explanatory view showing an entire configuration of the system for selling custom-made shoes at a store. As shown in FIG. 1, a terminal 32 and a measuring apparatus 34 and a 3D printer 36 connected to the terminal 32 are installed in a shoe store 30. The terminal 32 is communicatively connected to a last design server 20 through a communication network 50, such as the Internet or LAN.

The terminal 32 is a computer, such as a notebook computer or a tablet PC, and is equipped with a display and input devices (such as a keyboard, a mouse pad and a touch panel). A dedicated application program for accessing the last design server 20 may be installed in the terminal 32, or the terminal 32 may access the last design server 20 using a general-purpose browser.

The measuring apparatus 34 measures the three-dimensional shape of a foot and transmits foot data, i.e., the measured three-dimensional data, to the terminal 32. The terminal 32 transmits the foot data and related data relating to the foot to the last design server 20 through the communication network 50.

The 3D printer 36 operates under the control of the terminal 32 and shapes a structure including a last body for fabricating a last. In order to shape the structure including the last body, the terminal 32 receives last body processing data from the last design server 20 and controls the operation of the 3D printer 36 on the basis of the last body processing data. At the shoe store 30, the last body is taken out from the structure shaped by the 3D printer 36, and a shoe is manufactured using the fabricated last.

The last design server 20 includes a communication section 21, a control section 22 and a storage section 27. The server may include a keyboard and a display, although these are not shown.

The communication section 21 is connected to the communication network 50 and relays data transmission and reception between the terminal 32 and the control section 22.

The storage section 27 is configured as a storage device, such as a semiconductor memory or a hard disk, and includes a foot database 28 and a shoe database 29.

The foot database 28 is a database in which identifiers (for example, registration numbers), foot data, and related data are stored in mutual association. The related data includes, for example, the age, the sex, the exercise history, the characteristics of foot motion, the presence or absence of hallux valgus, flat foot, etc., and the taste for shoe fitting of a person whose foot data has been measured. The foot database 28 can be searched and data can be registered in the foot database 28 by operating the terminal 32 of the shoe store 30.

Data on shoes with various designs has been registered in the shoe database 29. For example, an identifier (for example, a commodity code of shoes) and shoe information (the use, the kind of design, the size, the color, the materials, the three-dimensional shape, the standard shape of a last, and the image figure of each shoe) are stored in mutual association in the database. The shoe information can be referred to or used for comparison by operating the terminal 32 of the shoe store 30 and by accessing the shoe database 29.

The control section 22 is configured as a central arithmetic processing unit including a CPU, includes a database management section 23, a last design section 24, a shoe-wearing simulation section 25 and a temporary shoe design section 26, and carries out processing, such as arithmetic operation and control, according to predetermined programs.

The database management section 23, for example, registers, updates, and reads data, in the foot database 28 and the shoe database 29. For example, the database management section registers the foot data and the related data received from the terminal 32 in the foot database 28 and transmits the shoe information read from the shoe database 29 to the terminal 32. The last design section 24 automatically designs the surface shape of a last and creates wood body processing data for processing a last body using the 3D printer. The shoe-wearing simulation section 25 creates a shoe-wearing image figure at the time when the shoe with the selected design is worn. The temporary shoe design section 26 creates temporary shoe processing data for shaping a temporary shoe for trial fitting using the 3D printer. However, one or both of the shoe-wearing simulation section 25 and the temporary shoe design section 26 may be omitted.

The type of the 3D printer 36 of the shoe store 30 is not limited particularly. For example, since a 3D printer, conforming to a molten substance depositing method in which a thermoplastic resin is melted by a heater and discharged from a nozzle, is available inexpensively and filament-shaped materials for use in shaping are readily available, this type of 3D printer is practical.

Although only one 3D printer may be used at the shoe store, it is preferable that two 3D printers should be prepared. In the case that two 3D printers are prepared, a pair of last bodies corresponding to left and right feet can be shaped simultaneously in parallel using the two separate 3D printers, whereby the time required in this case can be made shorter than the time required in the case that the pair of last bodies is shaped using one 3D printer. Furthermore, even if one of the 3D printers becomes faulty, the shaping of the pair of last bodies can be continued using the other 3D printer and a pair of lasts can be fabricated.

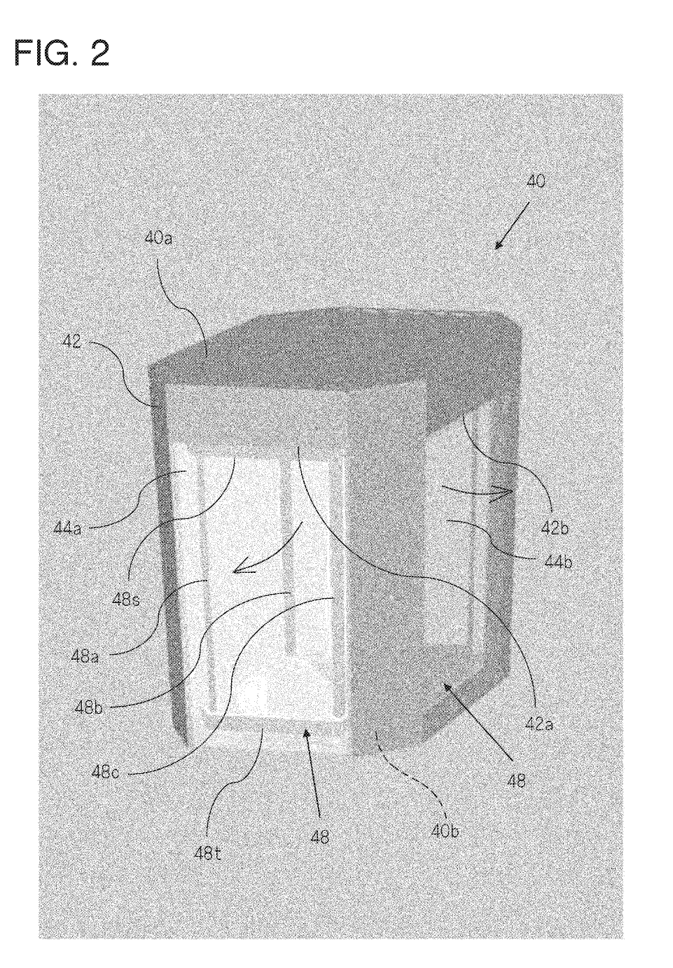

FIG. 2 is an image figure showing a 3D printer system 40 equipped with two 3D printers 48. As shown in FIG. 2, two delta type 3D printers 48 are accommodated in the housing 2 of the 3D printer system 40.

The housing 42 has a prismatic cubic shape, the upper face 40a and the lower face 40b thereof have a nearly rhombic shape, openings 42a and 42b are formed on the left and right sides of the front face thereof, and transparent doors 44a and 44b are provided at the openings 42a and 42b. As indicated by arrows, the left side door 44a opens to the left side, and the right side door 44b opens to the right side. With this configuration, the space can be utilized effectively, shaped structures can be taken out easily, and the printer system can be installed in a restricted place.

In the 3D printer 48, three pillars 48a, 48b and 48c are connected between upper and lower frames 48s and 48t having a nearly equilateral triangular shape. The 3D printer 48 is equipped with (a) three movable blocks that move along the respective pillars 48a, 48b and 48c, (b) a head section provided with a nozzle for discharging a shaping material, (c) three connection bars, one end of which is connected to any one of the movable blocks and the other end of which is rotatably connected to the head section, and (d) drive mechanisms for driving the respective movable blocks, although these are not shown. Since the position of the head section is uniquely determined corresponding to the positions of the three movable blocks, the three-dimensional position of the head section can be controlled by operating the drive mechanisms using control signals from the terminal 32 and by positioning the three movable blocks. In the 3D printer 48, the nozzle moves while discharging the shaping material to shape a structure. The head section may be provided with a plurality of nozzles.

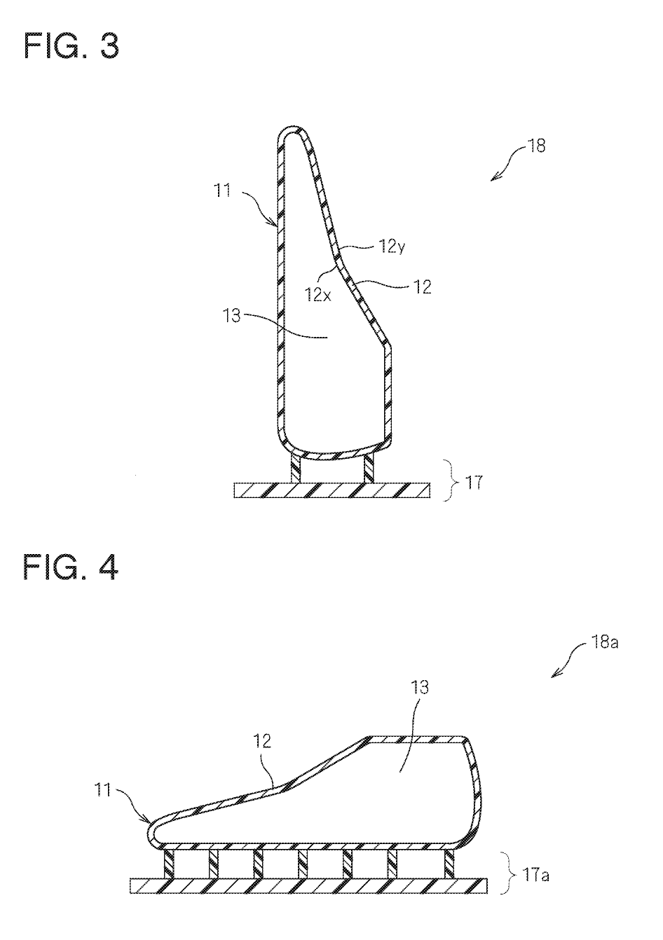

Next, processing for fabricating a last 10 in the shoe store 30 will be described referring to the sectional views in FIGS. 3 to 5.

First, as shown in FIG. 3, a structure 18 in which a support structure 17 is connected to a last body 11 is shaped using the 3D printer 36. The last body 11 has an outer section 12, and a hollow space 13 is formed in the inside of the outer section 12. The last body 11 may include structures (for example, ribs and pillars connected to the inner face 12x of the outer section 12) other than the outer section 12. The surface shape of the last 10 is formed by the outer face 12y of the outer section 12.

The support structure 17 and the structure 18 can be configured appropriately. In the case of the structure 18 in which the support structure 17 is connected to the last body 11 such that the toe side of the last body 11 is placed up and the heel side thereof is placed down as shown in FIG. 3, the horizontal movement range of the nozzle for discharging the shaping material is smaller than that in the case of a structure 18a in which a support structure 17a is connected to the last body 11 such that the toe side and the heel side of the last body 11 are made nearly horizontal. Hence, a compact 3D printer can be used, and the installation area of the 3D printer can be made small.

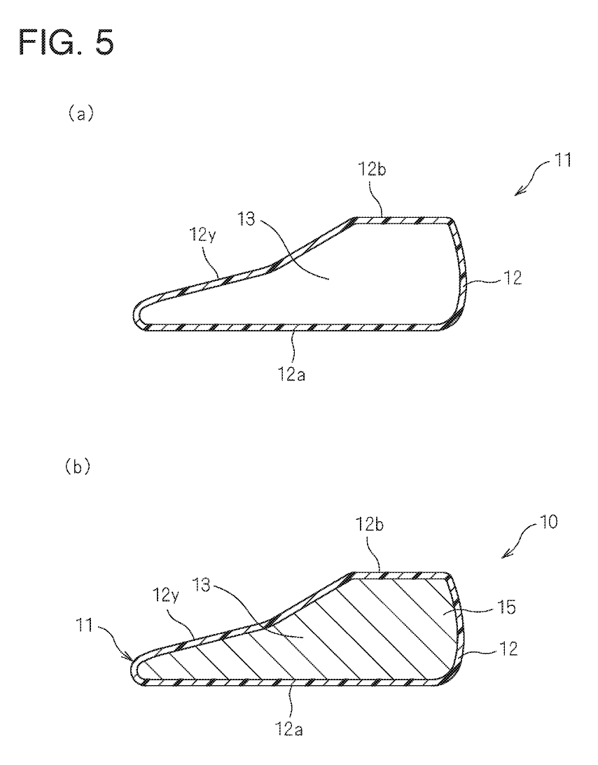

Next, as shown in FIG. 5(a), the support structure 17 is separated from the structure 18 and the last body 11 is taken out. The last body 11 and the support structure 17 can be separated by an appropriate method, such as cutting or resolution. For example, in the case that the support structure 17 is shaped using a polylactic acid resin (PLA resin), after the structure 18 is shaped, the support structure 17 can be removed by hydrolyzing the support structure using an alkaline aqueous solution.

Next, as shown in FIG. 5(b), a filling material 15 being in an uncured state is injected into the hollow space 13 of the last body 11. After the filling material 15 is cured, the last 10 is completed.

For example, the outer section 12 of the last body 11 is shaped so that a through hole passing through the outer section 12 and communicating with the hollow space 13 is formed, and the filling material 15 is injected through the through hole. Alternatively, the through hole passing through the outer section 12 and communicating with the hollow space 13 is formed later in the shaped last body 11, and the filling material 15 is injected through the through hole. The through hole may merely be formed at an appropriate position, preferably at a portion not affecting the manufacturing of a shoe, such as the center of the sole section 12a or the center of the foot insertion section 12b. The through hole may be blocked with a seal or the like after the filling material 15 is injected.

Appropriate materials may merely be used for the last body 11 and the filling material 15. For example, the last body 11 is shaped using a material consisting essentially of a thermoplastic resin, such as acrylonitrile butadiene styrene resin (ABS resin) or polylactic acid resin (PLA resin), or a photo-curable resin, and for the filling material 15, a material consisting essentially of at least one of plaster, cement, foamed urethane, non-foamed urethane, elastomer and photo-curable resin is used. In this case, the last body 11 is shaped so that nails can be driven thereinto and the strength of the last 10 is secured using the filling material 15, whereby the last 10 that can be used for manufacturing a shoe can be manufactured simply using an inexpensive 3D printer. As the method for performing shaping using a 3D printer, a selective material supplying system, such as a material extruding method in which a liquid or a plasticized solid is extruded from a nozzle and then deposited and solidified simultaneously may be used, or a selective solidifying system, such as a vat photo-polymerization method in which a liquid of a photo-curable resin is selectively irradiated with light, such as laser light, and solidified may also be used.

The last 10 capable of being bent may be manufactured using flexible materials for the last body 11 and the filling material 15. In this case, for example, after a shoe is manufactured using the last 10, the last 10 can be extracted easily from the shoe.

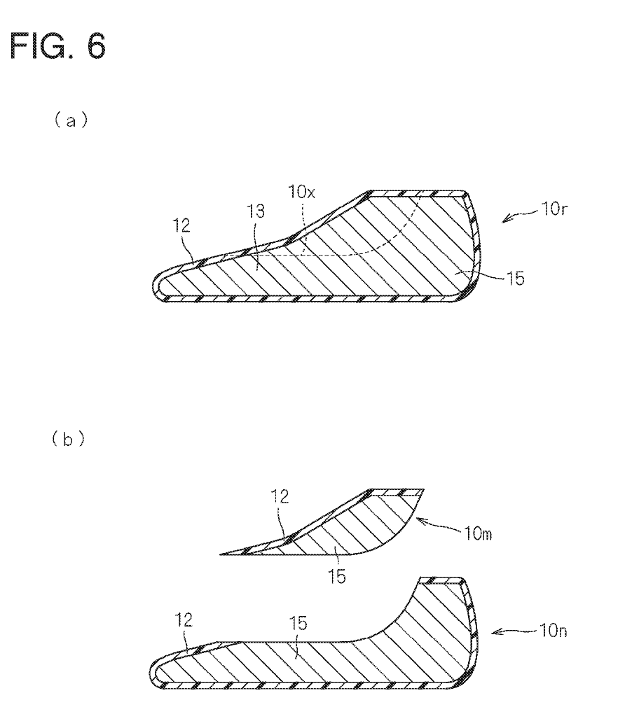

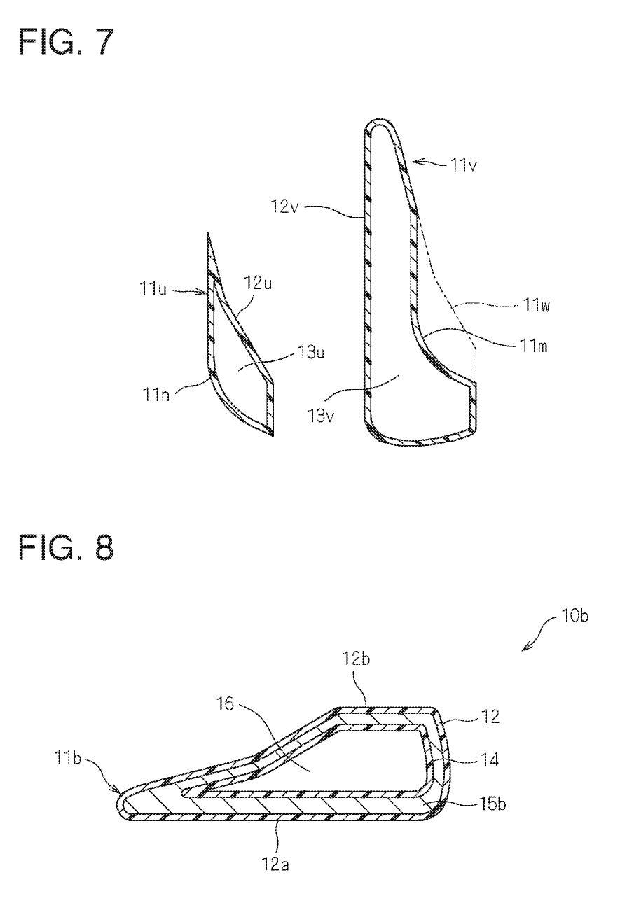

Moreover, split type lasts may also be fabricated. Split types are available, such as an instep-cutting type, a center-folded type and a sliding type; each type of last is divided and extracted when it is extracted from a manufactured shoe. FIGS. 6 and 7 are sectional views showing steps for manufacturing the instep-cutting type last.

First, as shown in FIG. 6(a), an integrated last 10r wherein the filling material 15 is injected into the hollow space 13 inside the outer section 12 is manufactured. And then the instep portion of the last 10r is cut off along the cutting line 10x indicated by a broken line, whereby two divided lasts 10m and 10n are fabricated as shown in FIG. 6(b). Holes, grooves, etc. into which positioning pins are inserted are provided in the lasts 10m and 10n by additional processing as necessary.

As shown in FIG. 7, two divided lasts may also be manufactured from the beginning by shaping a last body 11u for only the instep portion and a last body 11v lacking a portion 11w corresponding to this last body 11u. In this case, for example, the outer sections 12u and 12v of the last bodies 11u and 11v are shaped simultaneously using the 3D printers in the state of being arranged side by side as shown in FIG. 7, and then the filling material is injected into the respective hollow spaces 13u and 13v inside the respective outer sections 12u and 12v. Concave and convex sections engaging with each other can be formed on the overlapping faces 11m and 11n of the last bodies 11u and 11v to facilitate positioning and separation.

The filling material may merely be disposed inside the outer section of the last body, that is, inside the hollow space, and may merely make contact with the outer section of the last body, and the filling material may be injected into only part of the inside of the last body, that is to say, only part of the hollow space; a cavity may be formed in the inside of the last.

Furthermore, as in the last 10b shown in the sectional view in FIG. 8, the last body 11b thereof may have a double structure. The last body 11b of the last 10b has an inner section 14 expanded inside the outer section 12 with a distance provided between the inner section 14 and the outer section 12 and also has connecting sections, not shown, for connecting the outer section 12 and the inner section 14. A filling material 15b is injected into the space between the outer section 12 and the inner section 14. The distance between the outer section 12 and the inner section 14 on the side of the sole section 12a is set to have a dimension through which nails can be driven, and the other portions are set to have dimensions capable of securing strength. A cavity 16 is formed inside the inner section 14. The amount of the filling material 15b to be used can be reduced and the last can be made light in weight by forming the cavity 16.

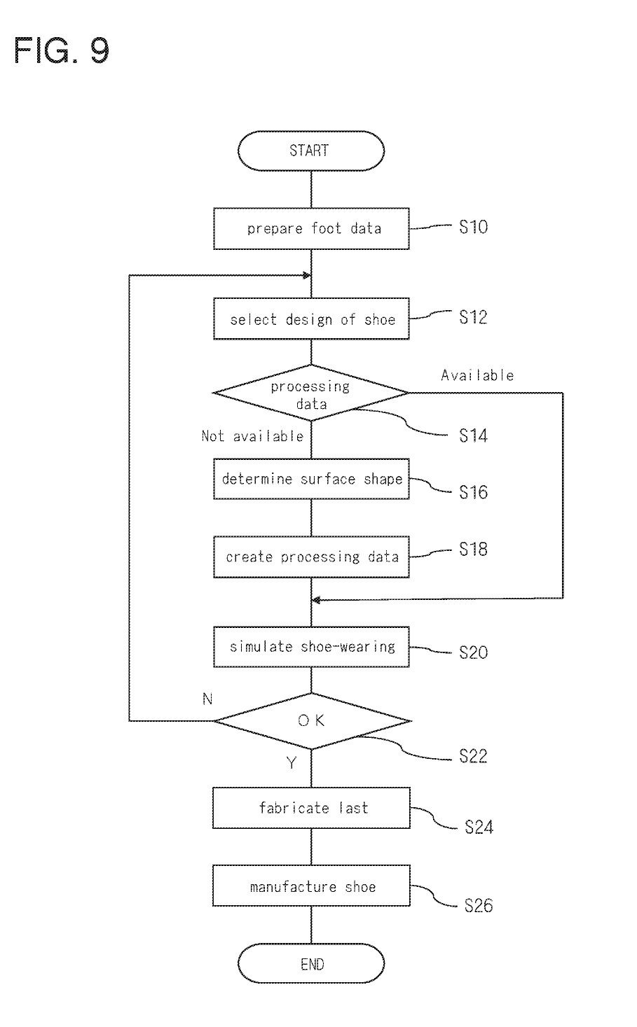

Next, an example of a procedure ranging from automatically designing a last using the last design server 20 to fabricating the last at the shoe store 30 will be described referring to FIG. 9. FIG. 9 is a flow chart indicating the procedure ranging from designing a last to fabricating the last.

As shown in FIG. 9, first, foot data, i.e., three-dimensional data, obtained by measuring the three-dimensional shape of a foot is prepared (at step S10, a data preparing step). The last design server 20 prepares the foot data. For example, the database management section 23 reads the foot data from the foot database 28 in response to a request from the terminal 32 of the shoe store 30 and transmits the read data to the last design section 24.

Next, the design of a shoe is selected (at step S12, a shoe design selecting step). Upon receiving the input of the identifier (for example, the registration number) of the shoe with the selected design through the terminal 32 of the shoe store 30, the database management section 23 of the last design server 20 reads shoe information from the shoe database 29 and transmits the read shoe information to the last design section 24.

And then, if the last body processing data for shaping the last body for the shoe with the selected design using the 3D printer is not available (“Not available” at step S14), (i) the surface shape of a last is determined on the basis of the foot data, i.e., the three-dimensional data, obtained by measuring the three-dimensional shape of the foot (at step S16, a surface shape determining step), (ii) last body processing data is created (at step S18, a last body processing data creating step), and (iii) the procedure advances to a shoe-wearing simulating step (at step S20). If the last body processing data for shaping the last body for the shoe with the selected design using the 3D printer is available (“Available” at step S14), (iii) the procedure immediately advances to the shoe-wearing simulating step (at step S20).

At step S16 (the surface shape determining step), the last design section 24 of the last design server 20 determines the surface shape of the last on the basis of the foot data and the shoe information transmitted from the database management section 23.

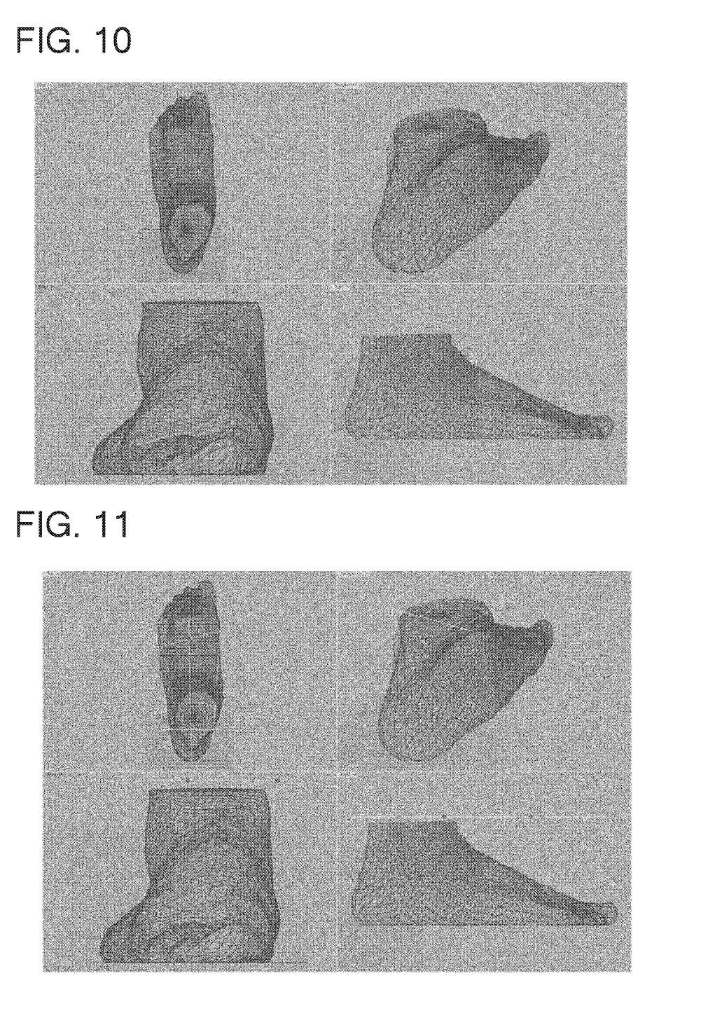

The last design section 24 of the last design server 20 automatically designs the surface shape of the last on the basis of the foot data and the data of the last having the standard shape included in the shoe information. For example, the surface shape of the last is determined by following the procedure shown in the image figures in FIGS. 10 to 21.

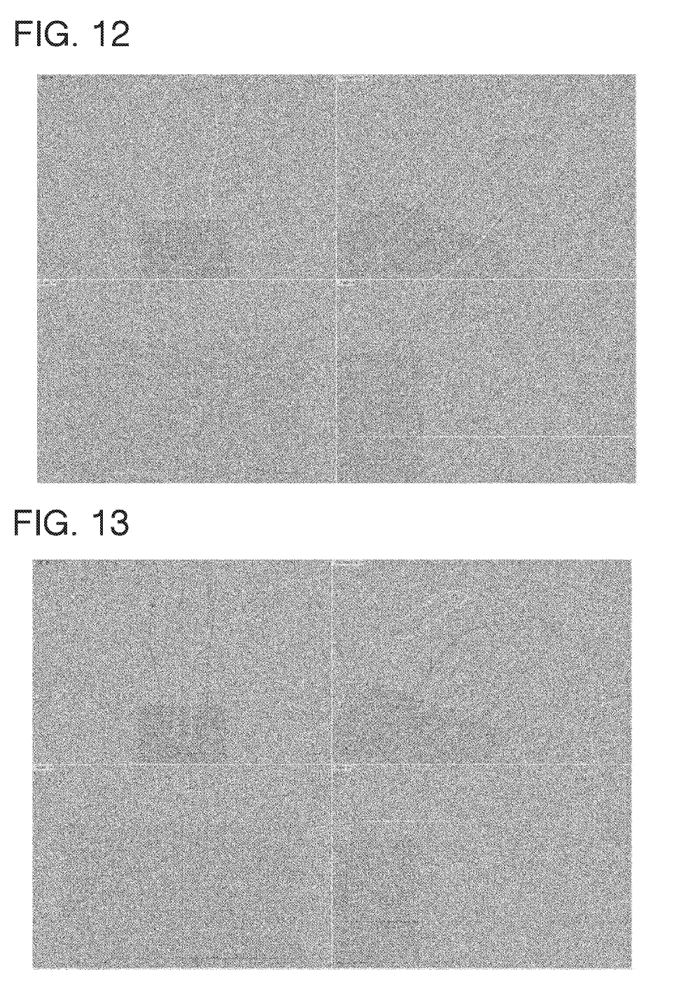

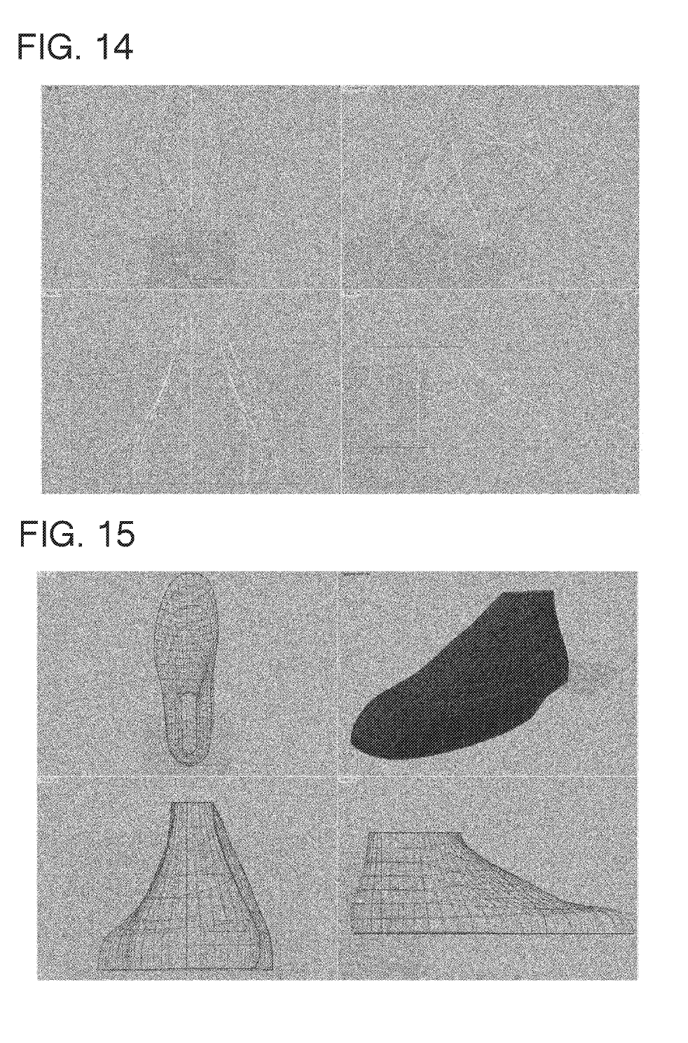

First, the foot data is read as shown in FIG. 10, an MP line is calculated as shown in FIG. 11, a bottom face gauge is created as shown in FIG. 12, a back line is created as shown in FIG. 13, and shape forming lines are created as shown in FIG. 14. And then, faces are attached along the shape lines, whereby the initial shape of the last is obtained.

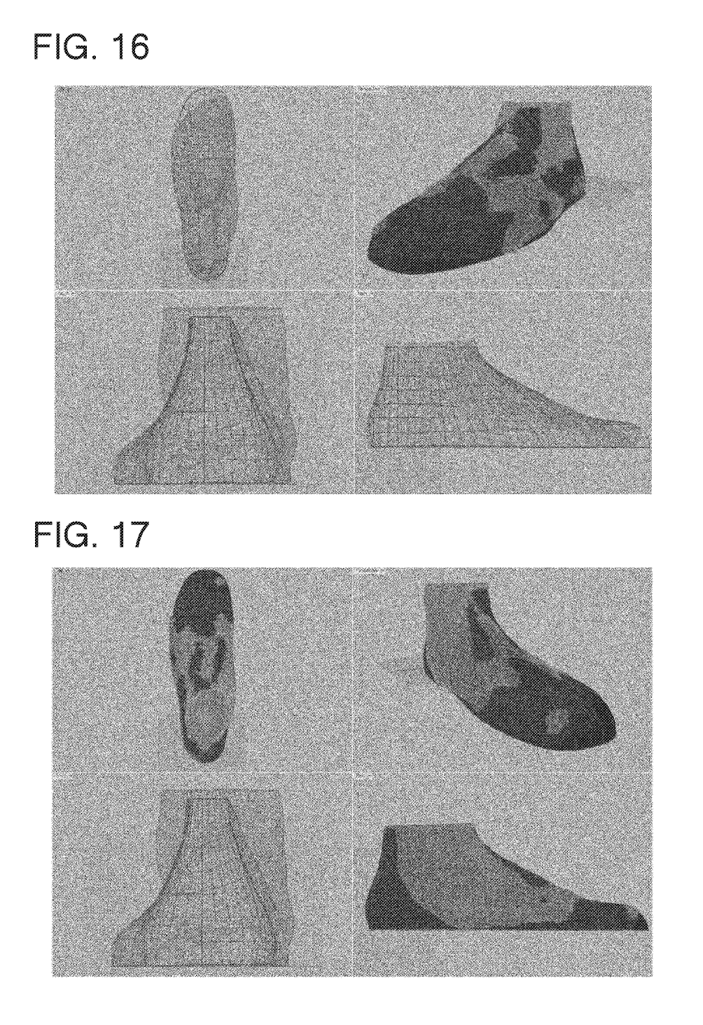

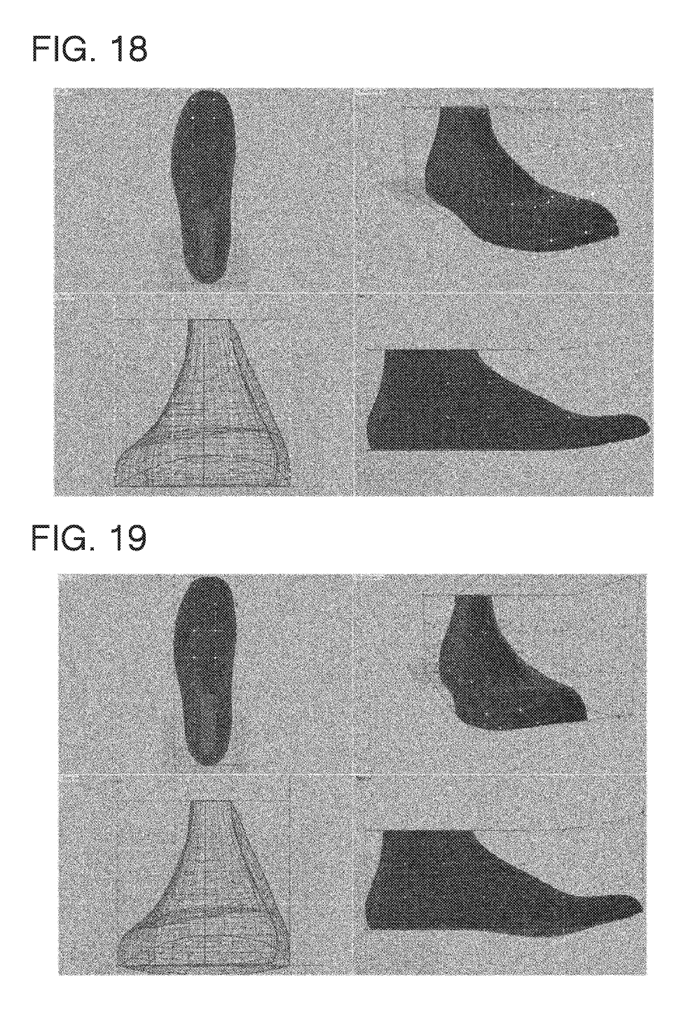

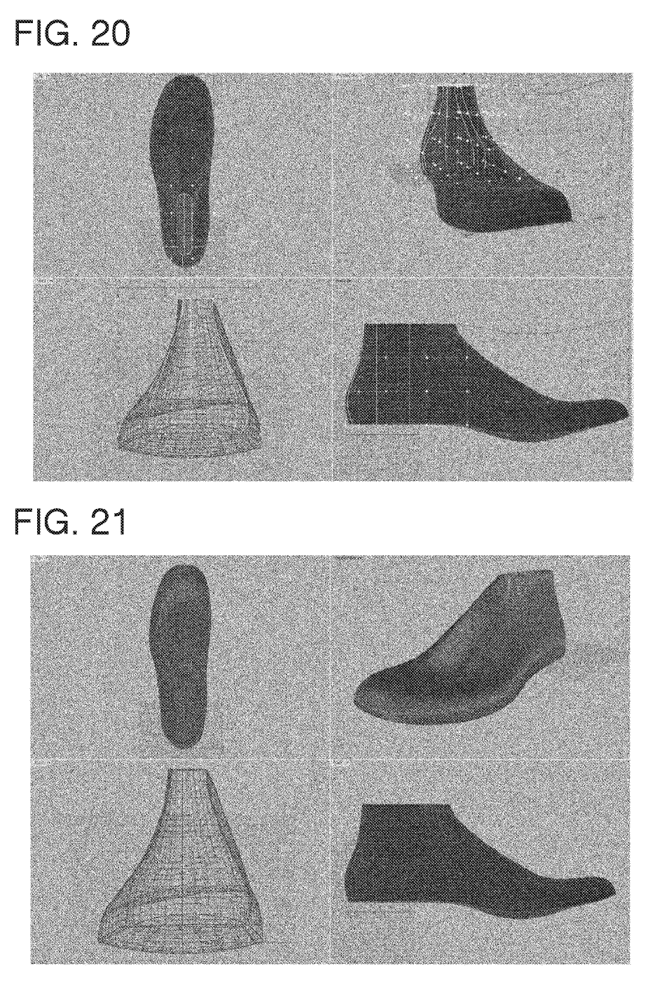

Next, the last and the foot are compared three-dimensionally as shown in FIG. 16, and then the shapes of various portions of the last are adjusted, for example, the last is adjusted as shown in FIG. 17, the shape of the toe of the last is formed as shown in FIG. 18, the sole of the last is adjusted as shown in FIG. 19, and the heel of the last is raised as shown in FIG. 20, whereby the surface shape of the last is determined as shown in FIG. 21.

At step S18 (a last body processing data creating step), the last design section 24 of the last design server 20 creates last body processing data for shaping the last body using the 3D printer according to a predetermined procedure so that the shape of the outer face of the outer section of the last body becomes coincident with the surface shape of the last having been determined at step S16 (the surface shape determining step).

The last body processing data may be the data of the three-dimensional shape data of the last body, the three-dimensional shape data of a structure in which support structures are connected to the last body, or control data for controlling the 3D printer in order to shape the structure in which the support structures are connected to the last body.

At step S20 (the shoe-wearing simulating step), a shoe-wearing image figure is created by simulating the shape of the shoe in the case that the shoe with the selected design is manufactured and worn. For example, the last design section 24 of the last design server 20 transmits required data to the shoe-wearing simulation section 25. The shoe-wearing simulation section 25 calculates the differences between the surface shape of the last determined at step S16 (the surface shape determining step) and the three-dimensional shape of the foot included in the foot data, corrects the image figure of the shoe included in the shoe information on the basis of the calculated differences to create a shoe-wearing image figure in the case that the shoe is worn, and transmits the image figure to the last design section 24.

Next, the shoe-wearing image figure is examined and a judgment is made as to whether the shoe with the selected design is adopted (at step S22). In the case of not adopting the selected design of the shoe (“N” at step S22), the procedure returns to step S12, and the selection of the shoe design is made again.

For example, the last design section 24 of the last design server 20 transmits the data of the shoe-wearing image figure to the terminal of the shoe store. The shoe-wearing image figure is displayed on the display of the terminal of the shoe store. In the case that the last design section 24 of the last design server 20 receives an input notifying a retry from the shoe store, the procedure returns to step S12.

In the case of adopting the shoe with the selected design (“Y” at step S22), a last is fabricated (at step S24, a last manufacturing step). At step S24 (the last fabricating step including a shaping step and an injecting step), an outer section having a hollow space is shaped using the 3D printer (at the shaping step), and a filling material being in an uncured state is injected into the inside of the outer section that has been shaped completely or shaped partly (the injecting step).

For example, upon receiving an input notifying the adoption of the shoe with the selected design from the terminal of the shoe store, the last design section 24 of the last design server 20 transmits the last body processing data to the terminal of the shoe store. After a predetermined operation for starting the operation of the 3D printer, the terminal of the shoe store controls the 3D printer so that the 3D printer shapes a structure including a last body on the basis of the last body processing data. In the case that the last body processing data is the three-dimensional shape data of the last body and the three-dimensional shape data of the structure in which the support structures are connected to the last body, the terminal of the shoe store converts the last body processing data into control data for controlling the 3D printer so as to shape the structure in which the support structures are connected to the last body having an outer section of a predetermined thickness and then controls the 3D printer. The last body is taken out from the shaped structure, and the filling material is injected into the inside of the last body, whereby the last is manufactured. Since the surface of the outer section of the last body is formed so as to become coincident with the surface shape determined at step S16 (the surface shape determining step), the surface of the last can be manufactured so as to become coincident with the surface shape determined at step S16 (the surface shape determining step).

Next, the shoe is manufactured using the fabricated last in a similar way as an ordinary last is used (at step S26, a shoe manufacturing step).

According to the above-mentioned procedure, after the confirmation of the shoe-wearing image figure at the time of wearing the shoe with the selected design, the last is actually fabricated and the shoe can be manufactured using the last. However, the last may be fabricated without confirming the shoe-wearing image figure and the shoe may be manufactured using the last by omitting steps S14, S20 and S22.

At step S10 (the data preparing step), the foot data and related data relating to the foot may be prepared, and at step S16 (the surface shape determining step), the surface shape of the last may be determined in consideration of information included in the related data, such as preference in fitting and characteristics of foot motion.

At step S24 (more specifically, the shaping process in the last fabricating step), it is preferable that the outer sections of the last bodies of a pair of lasts corresponding to left and right feet should be manufactured simultaneously using two 3D printers described above. For example, as in the above-mentioned 3D printer system 40 (see FIG. 2), two 3D printers are used. In this case, the outer sections of the pair of lasts can be shaped in a shorter time than in the case that the outer sections of the pair of lasts are shaped using a single 3D printer. Furthermore, since the two 3D printers are prepared, in the case that one of the 3D printers cannot be used, the outer sections of the pair of lasts can be shaped using the other 3D printer, whereby the fabricating of the pair of lasts can be continued.

Furthermore, at step S24 (more specifically, the injecting step in the last fabricating step), at least part of the filling material may be injected into the inside of the outer section of the last body being shaped partly instead of injecting the filling material collectively after the last body has been shaped. For example, the injection of the filling material may be performed simultaneously with the shaping of the outer section, or the injection of the filling material may be performed by interrupting the shaping of the outer section. In this case, the time required for the last fabricating step can be made shorter than in the case that the filling material is injected and cured after the shaping of the outer section. Moreover, even in the case of a filling material that generates heat or changes in volume when it cures, the last can be fabricated while relieving the influence of the heat generation and the change in volume by injecting the filling material little by little.

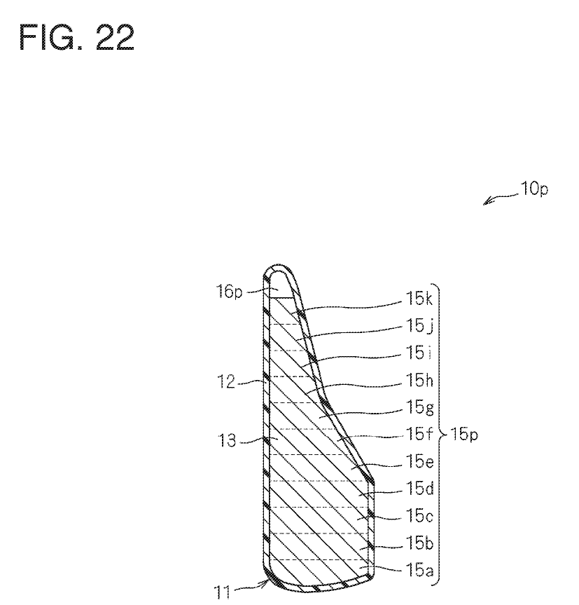

For example, as shown in the sectional view in FIG. 22, while the last body 11 is shaped, a filling material 15p being in an uncured state is injected into the hollow space 13 inside the outer section 12 for a plural number of times, whereby the layers 15a to 15k of the filling material 15p are formed sequentially. The filling material 15p being in an uncured state may be injected without interrupting the shaping of the last body 11, or the shaping of the last body 11 may be interrupted and the filling material 15p being in an uncured state may be injected during the interruption. A cavity 16p into which the filling material 15p is not injected may be formed inside the outer section 12 of the last body 11.

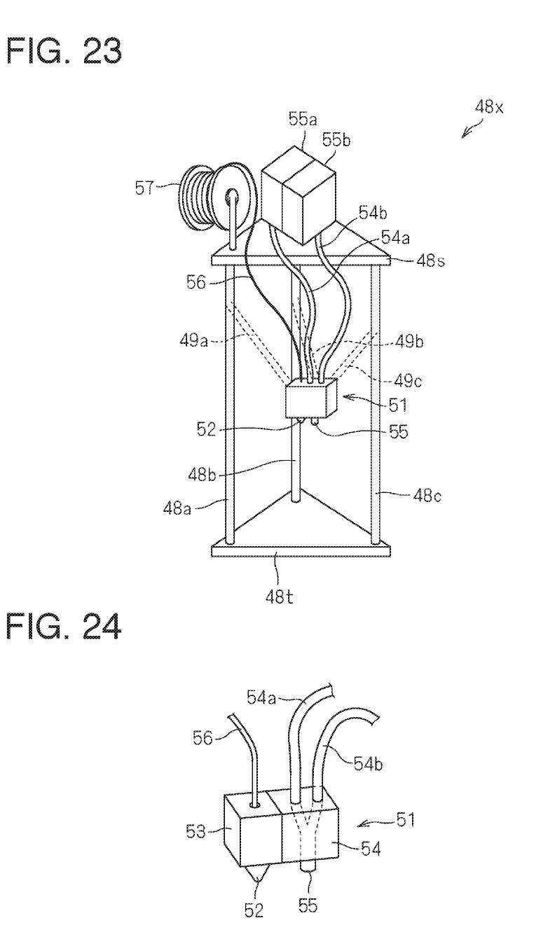

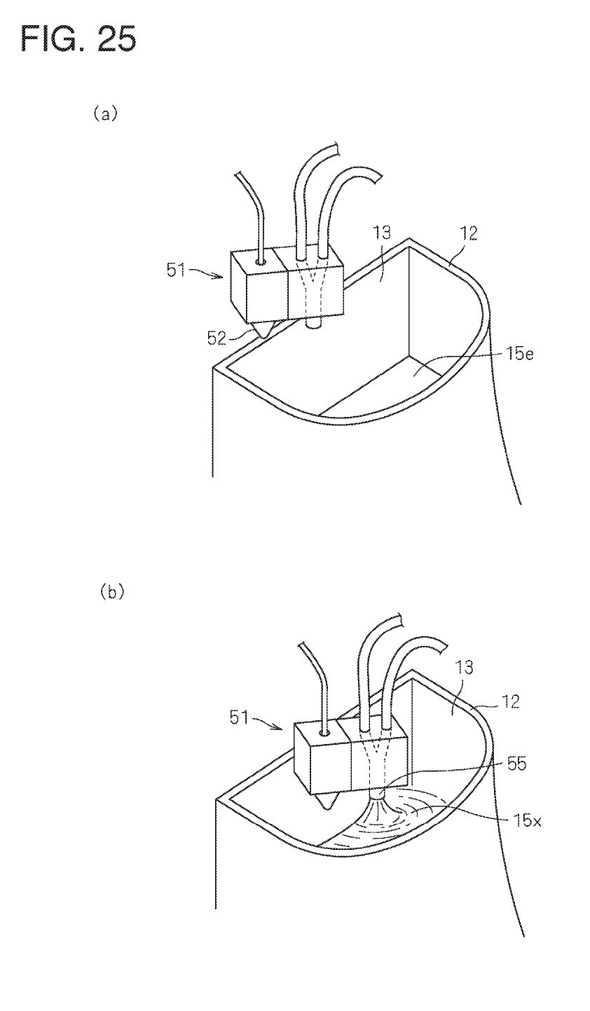

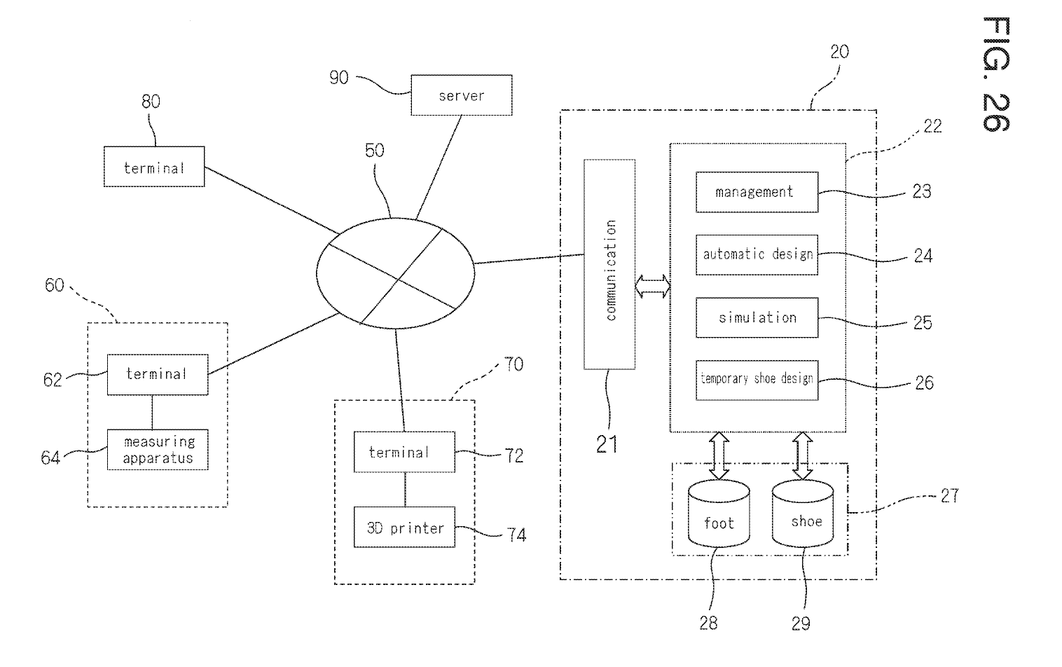

Next, a 3D printer capable of injecting a filling material while a structure is shaped will be described referring to FIGS. 23 to 25. FIG. 23 is a schematic view showing a 3D printers 48x. FIG. 24 is a schematic view showing the head section 51 of the 3D printers 48x. FIG. 25 is an explanatory view showing the operation of the head section 51 of the 3D printers 48x.

As shown in FIG. 24, the head section 51 is provided with a heater 53 for heating the base material (filament) 56 of a shaping material, a shaping nozzle 52 for discharging the melted shaping material, a mixer 54 for mixing liquid A and liquid B supplied from a first pipe 54a and a second pipe 54b, and a filling material supply port 55 from which the filling material being in an uncured state and obtained by mixing the liquid A and the liquid B is discharged. The mixer 54 may be provided in a place other than the head section 51, for example, on the upper frame of the 3D printer. Furthermore, an additional material such as sand may be added to the liquid A and the liquid B and supplied to the mixer 54, and the filling material in which the additional material is dispersed may be discharged from the filling material supply port 55.

As shown in FIG. 25(a), the outer section 12 of the last body is shaped using the shaping material extruded from the shaping nozzle 52. As shown in FIG. 25(b), a filling material 15x being in an uncured state is supplied from the filling material supply port 55 into the hollow space 13 inside the outer section 12 of the last body. For example, the liquid A containing a foamed urethane base material and the liquid B containing a curing agent are mixed in a short time and discharged, whereby foamed urethane can be injected uniformly.

High space efficiency is obtained in the case that a base material reel 57 for supplying the base material (filament) 56, a tank 55a for supplying the liquid A and a tank 55b for supplying the liquid B are disposed on the upper frame 48s of the delta type 3D printers 48x as shown in FIG. 23. The movable blocks that move along the pillars 48a, 48b and 48c are not shown in FIG. 23. Moreover, connection bars 49a. 49b and 49c are simply shown.

A similar configuration is used even in the case that plaster is used as the filling material 15. In other words, a configuration is made such that a mixer for mixing plaster powder and water is provided and the mixture of the plaster powder and the water is supplied from a filling material supply port that is provided in the head section together with the shaping nozzle. The mixer may be provided in the head section or may be provided in a place other than the head section. Predetermined amounts of the plaster powder and the water are supplied to the mixer at appropriate timing, and the plaster powder and the water are stirred and mixed inside the mixer, and then the mixture of the plaster powder and the water is moved through pipes from the mixer to the filling material supply port and discharged from the filling material supply port, whereby the mixture is supplied into the hollow space 13 inside the outer section 12 of the last body. A configuration is made so that the pipes and related components can be air-flushed after the mixture of the plaster powder and the water have been discharged from the filling material supply port in order to prevent the mixture of the plaster powder and the water remaining inside from solidifying.

Still further, a photo-curable resin may also be used as the filling material. In this case, for example, the head section of the 3D printer is provided with, for example, the heater for heating the base material of the shaping material, the shaping nozzle for discharging the melted shaping material, a filling material supply port for supplying the photo-curable resin and a light for emitting ultraviolet light to cure the photo-curable resin. The light may be provided in a place other than the head section. The last body is shaped using the shaping nozzle, the photo-curable resin being in an uncured state is discharged from the filling material supply port into the hollow space in the last body being shaped, and ultraviolet light is emitted from the light to the photo-curable resin inside the hollow space of the last body to cure the resin. Both the surface side and the inside of the photo-curable resin inside the hollow space of the last body can be cured uniformly by the ultraviolet light emitted from the light. In the case that a lamp is additionally provided in a place other than the head section, the speed of the curing can be increased, and portions where the ultraviolet light does not reach can be eliminated, whereby the resin can be cured entirely. A photo-curable resin may also be used as the shaping material.

With a sensor (for example, an ultrasonic sensor) provided in the head section to detect the liquid level of the filling material supplied from the injecting nozzle, the supply of the filling material may be controlled while monitoring the distance from the sensor to the liquid level of the filling material using the sensor so that the filling material 15x does not overflow from the hollow space 13 inside the outer section 12 of the shaped last body 11.

Moreover, the filling material may be formed by respectively supplying a plurality of materials for forming the filling material, such as the liquid A and the liquid B, or plaster powder and water, into the hollow space of the last body and by mixing the materials inside the hollow space. In this case, the head section of the 3D printer is provided with a shaping nozzle for discharging the shaping material and also provided with a plurality of material supply ports for supplying the respective plurality of materials for forming the filling material. Each of the plurality of materials for forming the filling material is supplied from the material supply port corresponding thereto into the hollow space of the last body shaped using the shaping nozzle, and the filling material is formed by mixing the plurality of supplied materials inside the hollow space of the last body, and the filling material is cured. The plurality of material supply ports may be provided in a place other than the head section. A configuration may be made such that the head section or a section other than the head section is provided with a stirring apparatus having a stirring section, such as a propeller, and the stirring section is inserted into the hollow space of the last body to mix the plurality of materials supplied inside the hollow space of the last body while stirring the materials.

The above-mentioned 3D printer is not limitedly used for fabricating lasts, but can be used for manufacturing various kinds of products. That is to say, in the case that the 3D printer is configured as described below, the 3D printer can fabricate not only lasts but also manufacture various kinds of products.

More specifically, the 3D printer is configured so as to be equipped with a head section in which three-dimensional positions are controlled, a shaping material discharging section (for example, the shaping nozzle 52) provided in the head section, moving together with the head section and being capable of discharging a shaping material for shaping a structure, and a filling material supplying means capable of supplying a filling material, so as to be able to shape a structure having a cavity, and so as to be able to supply the filling material into the cavity of the structure.

The filling material supplying means is preferably provided in the head section and includes a filling material supply port from which the filling material is discharged. In this case, the configuration is made simpler than the case in which the filling material supply port is provided in a place other than the printer head.

The filling material supplying means preferably includes a mixer that mixes a plurality of materials to generate the filling material. In this case, a filling material that cures in a short time after mixture can be injected efficiently.

It is preferable that the filling material supplying means should include a plurality of material supply ports for respectively supplying a plurality of materials that are mixed and formed into a filling material and should supply the plurality of materials to the cavity of the structure. In this case, the flushing of the filling material is not necessary. The material supply ports may be provided in the head section or in a place other than the head section. It is further preferable that the filling material supplying means should include a stirring apparatus capable of stirring the plurality of materials supplied into the cavity of the structure. In this case, the plurality of materials can be mixed more uniformly.

Furthermore, a function for designing a temporary shoe for trial fitting may be added by operating the temporary shoe design section 26 (see FIG. 1) included in the last design server 20. In this case, a shaping step for shaping a temporary shoe for trial fitting using a 3D printer on the basis of the surface shape determined at step S16, i.e., the surface determining step, is added after step S16, i.e., the surface determining step, and before step 24 (more specifically, the shaping step in the last fabricating step).

For example, in the flow chart in FIG. 9, after step S20 and before step 22, temporary shoe processing data for shaping a temporary shoe for trial fitting using a temporary shoe manufacturing 3D printer being the same as or different from the 3D printer for use in the shaping of a last body is created on the basis of the surface shape determined at step S16 (the surface determining step). Next, before step 22, the temporary shoe is manufactured using the temporary shoe manufacturing 3D printer on the basis of the temporary shoe processing data.

In this case, after the temporary shoe for trial fitting shaped using the 3D printer is worn and the contact state and the wear feeling of the shoe, for example, are confirmed, a last is fabricated actually, and a shoe can be manufactured using the last.

With the fabricating of the last according to the method described above, in the case that, for example, the outer section is shaped so that nails can be driven thereinto and the strength of the outer section is secured using the filling material, it is possible to fabricate a last into which nails can be driven and which is not broken or deformed even if pressure and impact are applied thereto. The outer section having a hollow space therein can be shaped using the 3D printer in a shorter time than in the case that the entire last is shaped using the 3D printer. Hence, the last that can be used for manufacturing a shoe can be manufactured in as short time as possible using the 3D printer.

Since the 3D printer is available inexpensively, has a small installation area, generates less dirt and dust, and generates less noise during operation, the 3D printer can be installed in a shoe store. The shoe store prepares parts for manufacturing shoes, fabricates lasts and manufactures shoes using the lasts, whereby the shoe store can deliver the shoes in a short time after order reception.

A plurality of terminals may be installed in the shoe store, and the measuring apparatus and/or the 3D printer may be connected to a terminal that is different from the terminal that is used to request last design to the last design server. Moreover, as in Embodiment 2 described later, it may be possible that the measuring apparatus and/or the 3D printer are installed in a place other than the shoe store and not installed in the shoe store.

In the case that the surface shape of a last is determined similarly on the basis of the three-dimensional shape of a standard foot and the last is designed and fabricated, the fabricated last can be used for the manufacturing of a ready-made shoe.

### Embodiment 2

A system for mail-order selling custom-made shoes according to Embodiment 2 for embodying the method of fabricating last according to the present invention will be described referring to FIG. 26.

The system for mail-order selling custom-made shoes according to Embodiment 2 is a system for mail-order selling shoes made to fit to the feet of customers (custom-made shoes). As in the system for selling custom-made shoes at a store, in the system for mail-order selling custom-made shoes, a last is automatically designed on the basis of the three-dimensional data of each foot of a customer; however, unlike Embodiment 1, a last is fabricated using a 3D printer at a shoe factory and a shoe can be manufactured using the last. In the following descriptions, components similar to those in Embodiment 1 are designated by the same reference numerals, and differences from Embodiment 1 are mainly described.

FIG. 26 is an explanatory view showing the entire configuration of the system for mail-order selling custom-made shoes. As shown in FIG. 26, the terminal 80 of a customer, a temporary store server 90, a terminal 62 installed at a foot measuring point 60, a terminal 72 installed at a shoe factory 70 and a last design server 20 having a configuration similar to that in Embodiment 1 are connected through a communication network 50, such as the Internet or LAN.

The terminal 80 of the customer is a mobile phone, a smart phone, a notebook computer having a communication function, etc., each being equipped with a display. The temporary store server 90 operates in cooperation with the last design server 20 and the terminal 72 of the shoe factory 70.

A measuring apparatus 64 is connected to the terminal 62 of the foot measuring point 60. The measuring apparatus 64 measures the three-dimensional shape of a foot and transmits foot data, i.e., measured three-dimensional data, to the terminal 62. The terminal 62 transmits the foot data and related data relating to the foot to the last design server 20 through the communication network 50.

A 3D printer 74 is connected to the terminal 72 of the shoe factory 70. At the shoe factory 70, a last body is taken out from the structure shaped by the 3D printer 74, a last is fabricated, and a shoe is manufactured using the last. The manufactured shoes are directly delivered to the customer.

With the system for mail-order selling custom-made shoes, shoes made to fit to the feet of customers can be manufactured at low cost. What's more, since the shoes made to fit to the feet of the customers are manufactured, the return of products occurs less frequently than in ready-made shoes.

In the case that temporary shoes for trial fitting are designed by operating the temporary shoe design section 26 included in the last design server 20, that the temporary shoes shaped using the 3D printer are delivered to the customers, that the contact state and the wear feeling of the shoes, for example, are confirmed, that lasts are actually fabricated, and that shoes are manufactured using the lasts, the return of products can be reduced further.

### Embodiment 3

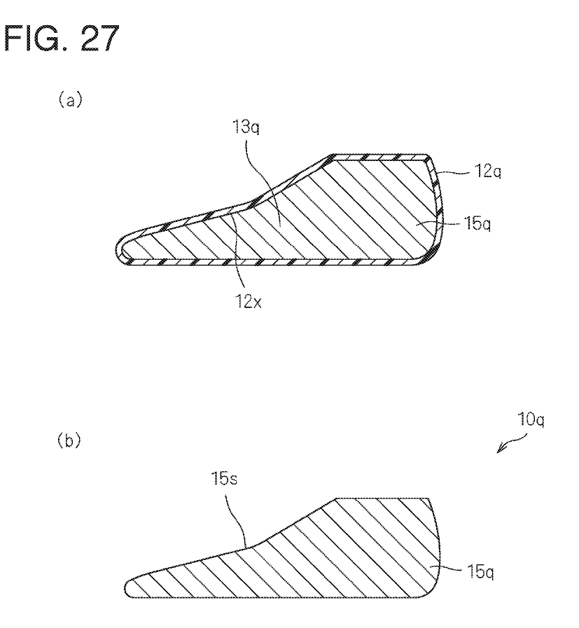

A method for manufacturing a last 10q according to Embodiment 3 will be described referring to FIG. 27. The method for manufacturing the last 10q according to Embodiment 3 is nearly similar to the method of fabricating last described in Embodiment 1, and differences from the method of fabricating last described in Embodiment 1 are mainly described.

FIG. 27 is a sectional view showing processing for fabricating the last 10q according to Embodiment 3. As shown in FIG. 27, after a filling material 15q being in an uncured state is injected into the hollow space 13q inside an outer section 12q, the outer section 12q is removed, and the remaining filling material 15q is used as the last 10q. For example, after the outer section 12q is shaped using a polylactic acid resin (PLA resin) and the filling material 15q is injected, the outer section 12q is resolved by carrying out hydrolysis using an alkaline aqueous solution, and then the resolved solution is removed. The outer section 12q may be shaped using a shaping material that is resolvable by a solvent. After the outer section 12q is removed by resolution, the last 10q can be taken out easily without damaging the surface of the last 10q on which the inner face of the outer section 12q has been transferred. However, the outer section 12q may be removed by cutting the outer section 12q and by peeling the outer section 12q from the filling material 15q.

The last 10q can be designed as in Embodiment 1. The data preparing step and the surface shape determining step are not required to be changed. At the last body processing data creating step, last body processing data for shaping the outer section 12q using the 3D printer is created so that the shape of the inner face 12x of the outer section 12q having a hollow space therein becomes coincident with the surface shape determined at the surface shape determining step. At the last fabricating step, the outer section 12q is shaped using the 3D printer on the basis of the last body processing data (at the molding step), and the filling material 15q being in an uncured state is injected into the outer section 12q (at the injecting step). After the injected filling material 15q is cured in the state of making contact with the inner face 12x of the outer section 12q, the outer section 12q is removed from the filling material 15q (at the removing step). Hence, the last 10q formed of the filling material 15q to the surface 15a of which the shape of the inner face 12x of the outer section 12q has been transferred is manufactured.

The last 10q that can be used at the time of manufacturing a shoe can be manufactured by appropriately selecting the materials of the outer section 12q and the filling material 15q. The outer section 12q having the hollow space 13q therein can be shaped using the 3D printer in a shorter time than in the case that the last 10q is entirely shaped using the 3D printer. Hence, the last 10q that can be used for manufacturing the shoe can be fabricated in as short time as possible using the 3D printer.

The method of fabricating last according to Embodiment 3 is not limited to the fabricating of lasts, but can be applied to the manufacturing of various kinds of products. In this case, like the last, a structure having a hollow space is shaped using the 3D printer, and a filling material being in an uncured state is injected into the hollow space of the structure, whereby an intermediate product is manufactured in which the filling material being cured and making contact with the inner face of the outer section is disposed inside the outer section. Next, the structure is removed from the intermediate product using an appropriate means, such as resolution. In other words, a mold of the structure is formed using the 3D printer, the shape of the mold is transferred to the filling material, and then the filling material is removed as a product. The method for curing the filling material is not limited to the method that uses heat, light, solvent or the like, and an elastomer exhibiting rubber elasticity at nearly normal temperature, rubber, etc. can be used as the filling material.

### SUMMARY

As described above, a last that can be used for the manufacturing of a shoe can be manufactured in as short time as possible by using a 3D printer.

However, the present invention is not limited to the above-mentioned embodiments, but can be embodied by making various modifications.

Each of the last design servers according to Embodiments 1 and 2 may be divided into a plurality of servers. For example, the server may be divided into a server for managing databases and a server for designing molds, and they are configured so as to cooperate with each other. Furthermore, part or whole of the functions of the last design server may be built in the terminal.

### DESCRIPTION OF REFERENCE NUMERALS AND SIGNS

10, 10b, 10m, 10n, 10q, 10r last
11, 11b, 11u, 11v last body
12, 12q, 12u, 12v outer section
12x inner face
12y outer face
13, 13q, 13u, 13v hollow space
14 inner section
15, 15b, 15p, 15q, 15x filling material
16, 16p cavity
20 last design server
34 measuring apparatus
36 3D printer
40 3D printer system
48, 48x 3D printer
64 measuring apparatus
74 3D printer

1. A method of fabricating last comprising:
a shaping step for shaping an outer section having a hollow space using a 3D printer and
an injecting step for injecting a filling material being in an uncured state into the inside of the outer section that has been shaped at the shaping step or that has been shaped partly at the shaping step.

2. The method of fabricating last according to claim 1, further comprising:
a surface shape determining step for determining the surface shape of a last on the basis of the three-dimensional data obtained by measuring the three-dimensional shape of a foot, wherein
at the shaping step, the outer section is shaped using the 3D printer so that the shape of the outer face of the outer section becomes coincident with the surface shape determined at the surface shape determining step, and
the last having the outer section and the filling material being cured and making contact with the inner face of the outer section is fabricated.

3. The method of fabricating last according to claim 2, wherein
at the shaping step, an inner section expanded inside the outer section with a distance provided between the inner section and the outer section is shaped together with the outer section using the 3D printer,
at the injecting step, the filling material being in an uncured state is injected into the space between the outer section and the inner section, and
the last having the filling material disposed between the outer section and the inner section is fabricated.

4. The method of fabricating last according to claim 1, further comprising:
a surface shape determining step for determining the surface shape of a last on the basis of the three-dimensional data obtained by measuring the three-dimensional shape of a foot, wherein
at the shaping step, the outer section is shaped using the 3D printer so that the shape of the inner face of the outer section becomes coincident with the surface shape determined at the surface shape determining step,
the method further comprises a removing step to remove the outer section from the filling material after the filling material injected at the injecting step is cured in the state of making contact with the inner face of the outer section so that
the last formed of the filling material to which the shape of the inner face of the outer section has been transferred is fabricated.

5. The method of fabricating last according to claim 1, wherein
at the shaping step, the outer section is shaped using a material consisting essentially of a thermoplastic resin or a photo-curable resin, and
the filling material being in a cured state consists essentially of at least one of plaster, cement, foamed urethane, non-foamed urethane, elastomer and photo-curable resin.

6. The method of fabricating last according to claim 1, wherein
at the injecting step, the filling material being in an uncured state is injected into the inside of the outer section having been shaped partly at the shaping step.

7. The method of fabricating last according to claim 1, wherein
at the shaping step, the outer sections of the pair of lasts corresponding to left and right feet are shaped simultaneously using the two separate 3D printers.

8. The method of fabricating last according to claim 1, further comprising:
a shoe design selecting step for selecting the design of a shoe before the shaping step and
a shoe-wearing simulating step for creating a shoe-wearing image figure of the shoe by simulating the shape of the shoe at the time when the shoe with the selected design is manufactured and worn before the shaping step.

9. The method of fabricating last according to claim 1, further comprising:
a temporary shoe shaping step for shaping a temporary shoe for trial fitting using a 3D printer being the same as or different from the 3D printer on the basis of the surface shape determined at the surface determining step after the surface shape determining step and before the shaping step.

10. A last comprising:
an outer section having a hollow space therein and
a filling material disposed inside the outer section and making contact with the outer section, wherein
the outer section is made of a material consisting essentially of a thermoplastic resin or a photo-curable resin, and
the filling material consists essentially of at least one of plaster, cement, foamed urethane, non-foamed urethane, elastomer and photo-curable resin.
